(19) United States
(12) Patent Application Publication
(10) Pub. No.: US 2007/0267019 A1
(43) Pub. Date: Nov. 22, 2007

(54) Manually operated respiration apparatus, and balloon unit and valve housing for a manually operated respiration apparatus

(76) Inventor: Gerardus Wilhelmus Lugtigheid, Spijkenisse (NL)

Correspondence Address: YOUNG & THOMPSON, 745 SOUTH 23RD STREET, 2ND FLOOR, ARLINGTON, VA, 22202, US

(21) Appl. No.: 11/364,005

(22) Filed: Mar. 1, 2006

Related U.S. Application Data
(63) Continuation of application No. PCT/NL04/00606, filed on Sep. 1, 2004.

(30) Foreign Application Priority Data
Sep. 1, 2003 (NL) 1024206

(51) Int. Cl. A61H 31/00

(52) U.S. Cl. 128/205.13

(57) ABSTRACT

A manually operated respiration apparatus, including a respiration housing, provided with a respiration channel for connection with a patient to whom artificial respiration is to be applied, which respiration channel is connected via a valve system connected to a balloon unit for supplying air to the patient via the respiration channel and with an outflow port for evacuation of air exhaled by the patient. The balloon unit includes a resilient bellows provided with a first opening with a non-return valve and a second opening. The second opening of the bellows is connected with the inflow port of the respiration housing. Upon squeezing the bellows, air exits the bellows via the second opening. Upon releasing the bellows, it rebounds and draws in air via the first opening. The bellows is provided with an overpressure protection for evacuating air from the bellows when a predetermined pressure value is exceeded.

This application is a continuation of PCT/NL2004/000606 filed Sep. 1, 2004. The PCT/NL2004/000606 application claims priority to Dutch application 1024206 filed Sep. 1, 2003.

### BACKGROUND OF THE INVENTION

1. Field of the Invention

The invention relates to a manually operated respiration apparatus, and to a balloon unit and to a valve housing for a manually operated respiration apparatus.

2. Description of the Related Art

Manually operated respiration apparatuses are known from practice and usually comprise a respiration housing, provided with a respiration channel for connection with a patient to whom artificial respiration is to be applied, which respiration channel is connected via a valve system in the respiration housing with an inflow port which is connected to a balloon unit for supplying air to the patient via the respiration channel, and which is further connected with an outflow port opening into the environment for evacuating air exhaled by the patient via the respiration channel to the environment. Here, the balloon unit comprises a resilient bellows provided with an inlet opening and an outlet opening, with a non-return valve being included in the inlet opening and with the outlet opening being connected to the inflow port of the respiration housing, all this such that, upon squeezing the bellows from a starting position, air enclosed by the bellows exits via the outlet opening and that, upon releasing the bellows, it rebounds to the starting position by sucking in environmental air via the inlet opening.

Such a manually operated respiration apparatus is known to a skilled person by the name of resuscitator and is used for manually applying artificial respiration to persons or animals, for instance during reanimation. Such a respiration apparatus has a simple construction and can easily be transported. Further, the apparatus has a high reliability, while a minimum of maintenance is required.

A drawback of the known respiration apparatus is that, thereby, the volume of the lungs of the patient can be increased too much, so that the lungs stretch too far. Such an overstretching of the lung leads to damage and dying off of lung cells, so that the oxygen transfer capacity of the lungs decreases. Although, after a few weeks, the lung cells have regenerated again and the oxygen transfer capacity is restored again, precisely the temporary decrease of the oxygen transfer capacity of the lungs can inflict great damage to the patient and even cause death of the patient.

In order to obviate this drawback, it has already been proposed to include an overpressure protection in the respiration housing to limit the pressure of the air supplied via the respiration channel at a predetermined value.

However, it has been found in practice that, despite this overpressure protection, overstretching of the lung is still caused during artificial respiration.

### SUMMARY OF THE INVENTION

The invention contemplates a manually operated respiration apparatus of the type referred to in the introduction, by means of which these drawbacks can be prevented while preserving the advantages.

For this purpose, the respiration apparatus according to the invention is characterized in that the balloon unit is further provided with an overpressure protection for evacuating air from the bellows to the environment when a predetermined pressure of the air in the bellows is exceeded.

It has been found that, in this manner, lung damage can be prevented in practice. The invention resides in the insight that, during the bustle of the reanimation and/or in case of use by less expert or untrained staff, the bellows can sometimes be squeezed too forcefully, so that a great pressure wave may be created which can insufficiently rapidly be evacuated via the overpressure protection included in the respiration housing, so that a considerable part of the pressure wave is still able to propagate via the respiration housing into the lungs of the patient. Particularly with a diseased or damaged lung in which the active volume is limited, this may result in severe damage. By providing the balloon unit with an overpressure protection, a rapid reduction of the pressure wave can be made possible, so that the pressure wave is prevented from reaching the lungs of the patient via the respiration housing and the respiration channel.

The balloon unit, particularly the bellows, is a suitable mounting place for such an overpressure protection, since, on or to the balloon, relatively much space is available for a relatively large outflow area of the overpressure protection, so that the flow resistance of the overpressure protection can be relatively low. Here, the overpressure protection may, for instance, be provided on the body of the bellows, but may also be provided in or to the inlet or outlet opening thereof.

By including an overpressure protection in the inlet opening, it is thus achieved that the overpressure protection can have a relatively large outflow area. Also, by inclusion in the inlet opening, it is achieved that the balloon unit of an already existing respiration apparatus—which is optionally provided with an overpressure protection in the respiration housing—can be equipped with a reliable overpressure protection in a simple manner. Further, this place is the most comfortable both for the operator of the balloon and for the patient.

In an advantageous embodiment, in the inlet opening of the bellows, a substantially cylindrical valve housing is included in which the non-return valve and the overpressure protection are accommodated. The non-return valve and the overpressure protection are preferably integrated, but may also form separate parts. The overpressure protection may, for instance, be designed as a spring-loaded valve. It is noted that the non-return valve and the overpressure protection may be integrated into one part, but that they may also be separate parts.

In a further advantageous embodiment, the cylindrical valve housing is, on an end face, provided with one or more suction openings and, on a part of the cylinder jacket located near the end face, provided with one or more blow-off openings. In this manner, it is achieved that, on its end face, the valve housing can be coupled with, for instance, an oxygen bag, while the blow-off openings remain clear.

In an advantageous manner, the cylindrical valve housing may be provided with a clamp for airtight clamping of the circumferential edge of the inlet opening.

The invention also relates to a method for manually applying artificial respiration to a patient.

Further advantageous embodiments of the invention are shown in the subclaims.

### BRIEF DESCRIPTION OF THE DRAWINGS

The invention will be further elucidated on the basis of exemplary embodiments which are shown in a drawing, in which:

FIG. 1 shows a diagrammatic longitudinal cross section of a respiration apparatus;

FIG. 2 shows a diagrammatic cross section of the respiration housing of the respiration apparatus of FIG. 1;

FIG. 3 shows a diagrammatic longitudinal cross section of a first embodiment of a valve housing;

FIG. 4 shows a diagrammatic longitudinal cross section of a second embodiment of a valve housing;

FIG. 5 shows a diagrammatic longitudinal cross section of a third embodiment of a valve housing; and

FIG. 6 and FIG. 7 each show a diagrammatic longitudinal cross section of a variant of the valve housing, in which the overpressure protection is settable.

### DESCRIPTION OF THE PREFERRED EMBODIMENTS

The drawings are only diagrammatic views of preferred embodiments of the invention which are provided by way of non-limiting exemplary embodiments. In the drawings, same or corresponding parts are designated by the same reference numerals.

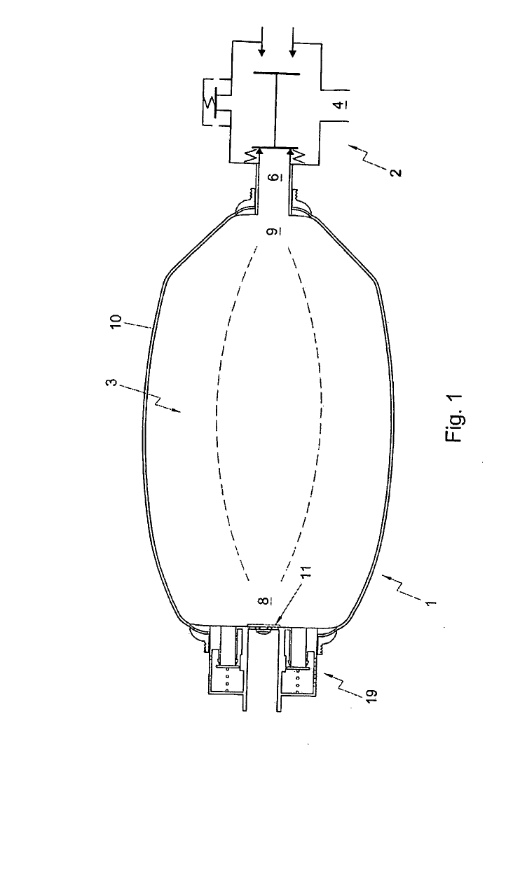

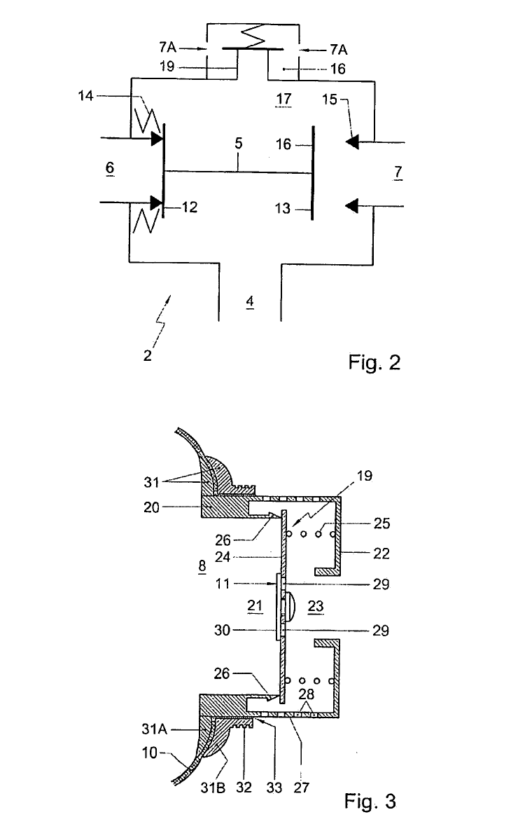

FIG. 1 shows a manually operated respiration apparatus 1, comprising a respiration housing 2 and a balloon unit 3 connected thereto. The respiration housing 2, which is shown in detail in FIG. 2, is provided with a respiration channel 4 which is connected via a valve system 5 with an inflow port 6 connected to the balloon unit 3 for supplying air to the patient via the respiration channel 4. The respiration channel 4 is further connected via the valve system 5 with one or more outflow ports 7 for evacuating the air exhaled by the patient into the respiration channel to the environment. The respiration channel 4 is, by its free end, connected with a mask (not shown) which is, during use, placed over the mouth and nose of the patient to whom artificial respiration is to be applied, or with a tube (not shown either) placed in the respiratory tract for artificial respiration.

The balloon unit 3 comprises a resilient bellows 10 provided with an inlet opening 8 and an outlet opening 9. The resilient bellows 10 may, for instance, be designed as an airtight wall from flexible material, for instance plastic, which is supported by resilient, arched ribs. The resilient bellows 10 may also be formed in a different manner, for instance as a hollow, somewhat elongated ball with relatively thick walls from rubberlike material. Such a balloon unit is known to a skilled person as a balloon unit of the self-inflating type and will not be further elucidated here.

In the inlet opening 8 of the bellows 10, a non-return valve 11 is included in a manner which will be further elucidated hereinbelow. The outlet opening 9 of the bellows 10 is connected with the inflow port 6 of the respiration housing 2. Upon squeezing the bellows 10 from the starting position shown in FIG. 1, air enclosed by the bellows exits via the outlet opening 9. With reference to FIG. 2, the exiting air enters the inflow port 6 of the respiration housing 2 and flows via non-return valve 12 of the valve system 5 into the respiration channel 4. The valve body simultaneously closes off outflow ports 7. Via the respiration channel 4 and the mask, the air is supplied via nose and mouth to the lungs of the patient. Upon releasing the bellows 10, the bellows rebounds to the starting position shown in FIG. 1 by sucking in environmental air via the non-return valve 11 provided in the inlet opening 8. Thereby, the non-return valve 12 in the respiration housing 2 slams shut.

With reference to FIG. 2, during and after the rebound of the resilient bellows 10, the patients will exhale air into the respiration channel 4. By air exhaled into the respiration channel 4 and/or by action of spring 14, the valve body 13 of valve system 5 will get off its seating 15 to the position shown in FIG. 2 in which the exhaled air can be evacuated to the environment via the outflow ports 7 of the respiration housing 2.

The respiration housing 2 may optionally be provided with an overpressure protection for evacuating air to the environment when a predetermined pressure value in the respiration housing is exceeded. In this exemplary embodiment, the overpressure protection is designed as a spring-loaded valve 16 in the wall of a chamber 17 in the respiration housing 2, which chamber connects to the inflow port 6. Given an elevated pressure, the valve body of the overpressure protection 16 is pressed from its seating 19 against the action of the spring, so that the air can pass the wall of the chamber 17 and can be evacuated to the environment. Given an overpressure, the air can thus pass the overpressure protection 16 and be evacuated to the environment via outflow ports 7A. The construction of the respiration housing for a respiration apparatus is well enough known to a skilled person and will not be further elucidated here.

With reference to FIG. 1, in the inlet opening 8 of the bellows 10, an overpressure protection 19 is included for evacuating air from the bellows via the inlet opening 8 when a predetermined pressure value is exceeded. The overpressure protection included in the inlet opening comes into action when, as a result of squeezing the balloon too forcefully, the pressure in the balloon exceeds a predetermined value. By placement in the inlet opening 8, the pressure wave may be prevented from moving via the respiration housing 2 and the respiration channel 4 into the lungs of the patient.

With reference to FIG. 3, it is shown therein that, in the inlet opening 8 of the bellows 10, a substantially cylindrical valve housing 20 is included in which the non-return valve 11 and the overpressure protection 19 are integrated.

In the embodiment shown in FIG. 3, the valve housing 20 is provided with a central passageway 21 extending from a suction opening 23 provided in the end face 22 of the valve housing 20 to the interior of the bellows 10.

In the central passageway 21, a valve body 24 is included which is pressed against a seating 26 by action of a spring 25. The valve body 24, spring 25 and seating 26 together form the overpressure protection 19 which, during normal use, prevents outflow of gas from the balloon via the inlet opening 8. Given an overpressure caused by squeezing the bellows too forcefully, for instance given a pressure in the bellows of 60 cm water column, the valve body 24 will get off its seating 26 against the action of the spring 25, so that air from the bellows can flow out to the environment via outflow openings 28 provided in the jacket surface 27 of the valve housing 20, near the end face 22.

In the valve body 24, passage openings 29 are provided which are sealed on a side of the valve body 24 facing the bellows by means of a flexible valve body 30. The passage openings 29 and the flexible valve body 30 form a non-return valve 12 which prevents exiting of air from the bellows during squeezing, but which allows inflow of air from the environment to the interior of the bellows during the rebound.

The valve housing 20 is provided with clamping means 31 for airtight clamping of the circumferential edge of the inlet opening 8 of the bellows 10. In the embodiment shown in FIG. 3, the clamping means are formed by a supporting flange 31A provided on the valve housing 20, which cooperates with a pressure flange 31B of a screw ring 32 which is attached on the jacket 27 of the valve housing 20 by means of screw thread 33.

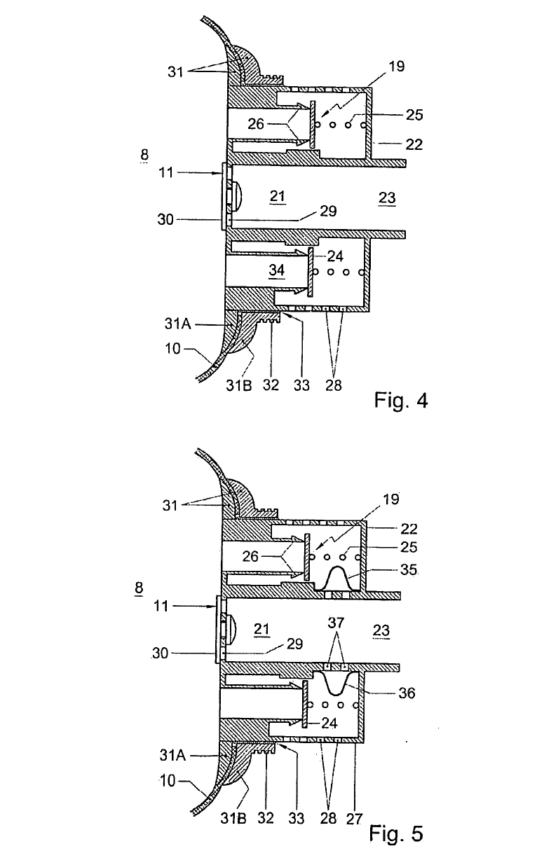

With reference to FIG. 4, a second embodiment of the valve housing 20 is shown therein, in which the valve body 24 has an annular design and is located in a blow-off channel 34 arranged around the central passageway 21. Here, the suction opening 23 has a cylindrical design and the blow-off channel 34 is arranged annularly around it. Here, the passageway 21 extends somewhat outwardly with respect to the end face 22, so that the suction opening 23 is located outside the end face 22. In this manner, the inflow opening can easily be connected to a bag. Via the bag, enriched air can be supplied to the balloon, for instance air with extra oxygen and/or a small amount of narcotic, such as laughing gas, for relief. Then, besides air, enrichment gas can likewise be continuously supplied to the bag from a gas cylinder with a relatively low flow rate, for instance 0-15 liters per minute.

Optionally, as shown in FIG. 5, an overpressure protection 35 may be provided in the wall of the central passageway 21 so that, when the pressure in the oxygen bag exceeds a predetermined value, oxygen can directly be evacuated to the blow-off channel 34. An example of such an overpressure protection is a duckbill valve 36 in the shape of a ring which clears passage openings 37 in the wall of the passageway given a pressure of approx 15 cm water column in the oxygen bag. For the record, it is noted that, when the respiration apparatus is coupled with an oxygen bag, the term air is to be interpreted to mean oxygen in this context.

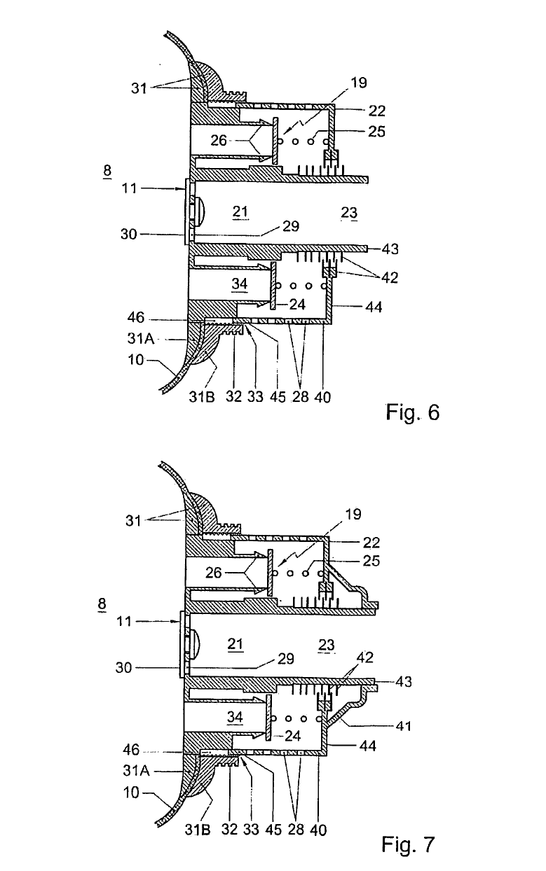

FIG. 6 shows a variant of the valve housing where the predetermined pressure value of the overpressure protection is settable. In this variant, the pressure value of the overpressure protection is settable between a pressure of approx 20 cm water column and a pressure of approx 60 cm water column. Of course, for less common applications of manual artificial respiration, an overpressure protection with a higher maximum pressure may be possible, for instance an overpressure protection with a setting range up to approx 80 or 120 cm water column.

Here, the settable overpressure protection is designed with a setting element designed with a rotatable part 40 of the housing of the valve housing. The rotatable part 40 is connected with a stationary part 43 of the valve housing via a screw thread connection 42.

Via the screw thread connection 42, the rotatable part 40 of the valve housing 20 is rotatable over an angle range of approx 270° with respect to the stationary part 43 of the valve housing. For obtaining a simple, unambiguous operation, the angle range is less than approx 360°, and is preferably between approx 90° and 360°. In this manner, the whole setting range can be traversed with a turn of the wrist, while further, with each angular position, exactly one pressure value corresponds. For the purpose of a stable construction, the jacket 45 of the rotatable part 40 is included in an annular guide 46.

Preferably, further, the closing pressure exerted on the valve body 24 by means of spring 25 can be set linearly. By using a screw thread 42 with variable pitch, the spring 25 can have a non-linear design, while a linear setting characteristic is still obtained across the angle range.

In an advantageous manner, the end face 44 of the rotatable part 40 of the valve housing may be graduated for reading the set value of the overpressure protection on the basis of the relative angular position between the adjustable part of the valve housing 40 with respect to the stationary part 43. For this purpose, for instance an annular graduation may be represented on the part of the end face 44 surrounding the stationary part 43 of the valve housing, while a reference line is provided on the end face of the screw ring 32 and/or the end face of the stationary part 43. The settable overpressure protection may of course also be applied to other variants of the valve housing.

With reference to FIG. 7, it is shown that the rotatable part 40 of the housing of the valve housing is provided with a control button 41 to facilitate the engaging.

Optionally, the suction channel 23 surrounded by the stationary part 43 of the valve housing may also be provided with a protective cap with passage openings, for instance a protective grid.

With the aid of the settable overpressure protection, the air present in the bellows can thus be blown off via a settable barrier in or to the bellows. It will be clear that the settable overpressure protection may further be designed in many different manners than the preferred embodiment described hereinabove. For instance, a settable overpressure protection may be realized with the aid of a slidable stop or an adjustable clamp and the adjustment can be carried out either continuously or discontinuously. Further, if desired, the predetermined pressure value may be non-linearly settable across the setting range.

It will further be clear that such a settable overpressure protection in itself can already be advantageously applied in conventional manually operated respiration apparatuses, in other words, a respiration apparatus in which the overpressure protection is not provided in or to the balloon unit. Such a manually operated respiration apparatus then comprises a respiration housing, provided with a respiration channel for connection with a patient to whom artificial respiration is to be applied, which respiration channel is connected via a valve system with an inflow port connected to a balloon unit for supplying air to the patient via the respiration channel and with one or more outflow ports for evacuating air exhaled by the patient into the respiration channel to the environment, while the balloon unit comprises a resilient bellows provided with an inlet opening and an outlet opening, while, further, in the inlet opening of the bellows, a non-return valve is included and while the outlet opening of the bellows is connected with the inflow port of the respiration housing, and while the respiration apparatus is provided with an overpressure protection for evacuating air from the respiration apparatus when a predetermined pressure value is exceeded, with the predetermined pressure value of the overpressure protection being settable.

It will be clear that the invention is not limited to the preferred exemplary embodiments shown herein, but that many variations are possible. For instance, the overpressure protections may be designed as overpressure protections with a settable initial value. Further, the overpressure protection may be integrated in the inlet opening with the non-return valve, for instance by designing a flexible valve body of a non-return valve such that it will leak in case of overpressure. Such variants will be clear to a skilled person and are understood to be within the scope of the invention as set forth in the following claims.

1. A manually operable respiration apparatus, comprising:
a respiration housing having an inflow port opening into the respiration housing, an outflow port opening into the respiration housing, and a respiration channel, the respiration channel opening into the respiration housing for supplying gas to a patient;
a balloon unit connected to the inflow port, the balloon unit comprising a resilient bellows constructed so that after being squeezed from a starting position, the bellows returns to the starting position, the balloon unit further comprising a non-return valve constructed to allow the gas to enter the balloon unit as the bellows returns to the starting position; and
a valve system constructed to allow the gas to travel from the inflow port to the respiration channel, and from the respiration channel to the outflow port;
wherein the bellows further comprises an overpressure protection valve constructed to open and allow a portion of the gas to escape the bellows without entering the respiration housing only while a pressure of the gas in the bellows exceeds a predetermined threshold value.

2. A manually operable respiration apparatus, comprising:
a respiration housing having an inflow port opening into the respiration housing, an outflow port opening into the respiration housing, and a respiration channel, the respiration channel opening into the respiration housing for supplying gas to a patient;
a balloon unit connected to the inflow port, the balloon unit comprising a resilient bellows constructed so that after being squeezed from a starting position, the bellows returns to the starting position, the balloon unit further comprising a non-return valve constructed to allow the gas to enter the balloon unit as the bellows returns to the starting position;
a valve system constructed to allow the gas to travel from the inflow port to the respiration channel, and from the respiration channel to the outflow port; and
wherein the balloon unit further comprises an overpressure protection valve at the non-return valve, the overpressure protection valve being constructed to open and allow a portion of the gas to escape the bellows without entering the respiration housing only while a pressure of the gas in the bellows exceeds a predetermined threshold value.

3. The respiration apparatus according to claim 1, wherein the bellows further comprises an opening, the non-return valve and the overpressure protection valve being arranged so that the gas passing through the non-return valve and the gas passing through the overpressure protection valve pass through the opening of the bellows.

4. The respiration apparatus according to claim 1, wherein the overpressure protection valve is adjustable.

5. The respiration apparatus according to claim 3, wherein the overpressure protection valve is adjustable.

6. The respiration apparatus according to claim 3, further comprising a valve housing, the non-return valve and the overpressure protection valve being disposed at the valve housing.

7. The respiration apparatus according to claim 6, wherein the valve housing is provided with one or more suction openings and wherein a part of a jacket surface of the valve housing is provided with one or more blow-off openings.

8. The respiration apparatus according to claim 6, wherein the valve housing comprises a clamp that secures the valve housing to the bellows.

9. A balloon unit for a manually operated respiration apparatus, comprising:
a resilient bellows constructed so that after being squeezed from a starting position, the bellows returns to the starting position; and
a first opening and a second opening, the first opening comprising a non-return valve constructed to allow passage of a gas from outside the balloon unit into the bellows;
wherein the bellows further comprises an overpressure protection valve constructed to open and allow a portion of the gas to escape the bellows without passing through the second opening only while a pressure of the gas in the bellows exceeds a predetermined threshold value.

10. A balloon unit for a manually operated respiration apparatus, comprising:
a collapsible means for manually increasing pressure of a gas and for resiliently returning to an original shape;
an outlet means for allowing the gas contained in the collapsible means to exit the collapsible means when the pressure on the gas is increased;
an inlet means for allowing the gas to enter the collapsible means as the collapsible means resiliently returns to the original shape;
an overpressure means for allowing a portion of the gas to exit the collapsible means without passing through the outlet means only while the pressure of the gas inside the collapsible means exceeds a predetermined threshold value.

11. A balloon unit for a manually operated respiration apparatus, comprising:
a resilient bellows constructed so that after being squeezed from a starting position, the bellows returns to the starting position; and
a combination valve, the combination valve comprising an inlet portion constructed to allow the gas to enter the bellows while the bellows returns to the starting position, the combination valve further comprising an overpressure portion that allows a portion of the gas to exit the bellows only while a pressure of the gas inside the bellows exceeds a predetermined threshold value.

12. A balloon unit for a manually operated respiration apparatus, comprising:
a resilient bellows constructed so that after being squeezed from a starting position, the bellows returns to the starting position; and
an overpressure protection valve comprising a movable element that is displaced from a rest position against a spring pressure when a pressure of a gas inside the bellows exceeds a predetermined threshold value; and
a non-return valve that allows gas to enter the bellows only while a pressure inside the bellows is lower than a pressure outside the bellows;
wherein the non-return valve is disposed on the movable element of the overpressure protection valve.

13. The balloon unit according to claim 9, wherein the overpressure protection valve is arranged so that the gas passing through the overpressure protection valve passes through the first opening of the bellows.

14. The balloon unit according to claim 9, wherein the overpressure protection valve is adjustable.

15. The balloon unit according to claim 9, further comprising a valve housing, the non-return valve and the overpressure protection valve being disposed at the valve housing.

16. The balloon unit according to claim 15, wherein the valve housing is provided with one or more suction openings and wherein a part of a jacket surface of the valve housing is provided with one or more blow-off openings.

17. The balloon unit according to claim 15, wherein the valve housing comprises a clamp that secures the valve housing to the bellows.

18. A method for manually applying artificial respiration to a patient, comprising steps of:
providing a balloon unit for a manually operated respiration apparatus, comprising:
a resilient bellows constructed so that after being squeezed from a starting position, the bellows returns to the starting position; and
an inlet opening and an outlet opening, the inlet opening comprising a non-return valve constructed to allow passage of a gas from outside the balloon unit into the bellows;
wherein the bellows further comprises an overpressure protection valve constructed to allow a portion of the gas to escape the bellows without passing through the outlet opening only while a pressure of the gas in the bellows exceeds a predetermined threshold value;
providing means for transferring the gas from the bellows to the patient; and
squeezing the bellows to supply the gas to lungs of the patient;
wherein the squeezing step is performed so that the bellows are squeezed with sufficient force to allow a portion of the gas to escape through the overpressure protection valve.

19. The respiration apparatus of claim 1, wherein the predetermined threshold value is adjustable over a range including 20 cm water column.

20. The balloon unit of claim 9, wherein the predetermined threshold value is adjustable over a range including 20 cm water column.

21. The respiration apparatus of claim 1, wherein the predetermined threshold value is adjustable over a range including 60 cm water column.

22. The balloon unit of claim 9, wherein the predetermined threshold value is adjustable over a range including 60 cm water column.

23. The respiration apparatus of claim 4, wherein the overpressure protection valve comprises a rotatable element that sets the predetermined threshold value.

24. The balloon unit of claim 14, wherein the overpressure protection valve comprises a rotatable element that sets the predetermined threshold value.

25. The respiration apparatus of claim 23, wherein the rotatable element is rotatable no more than 360°.

26. The balloon unit claim 24, wherein the rotatable element is rotatable no more than 360°.

27. The respiration apparatus of claim 6, wherein the valve housing comprises a graduation identifying a relative angular position between an adjustable part of the valve housing and a stationary part of the valve housing, wherein the predetermined threshold value is a function of a relative position of the adjustable part with respect to the stationary part.

28. The respiration apparatus of claim 27, wherein there is a linear relationship between relative angular displacement between the adjustable and stationary parts and a change in the predetermined threshold value.

29. The respiration apparatus of claim 1, further comprising a mask connected to the respiration channel.

30. The respiration apparatus of claim 1, further comprising a tube connected to the respiration channel.

31. The respiration apparatus of claim 2, further comprising a mask connected to the respiration channel.

32. The respiration apparatus of claim 2, further comprising a tube connected to the respiration channel.

33. The respiration apparatus according to claim 2, wherein the bellows further comprises an opening, the non-return valve and the overpressure protection valve being arranged so that the gas passing through the non-return valve and the gas passing through the overpressure protection valve pass through the opening of the bellows.

34. The respiration apparatus according to claim 2, wherein the overpressure protection valve is adjustable.

35. The respiration apparatus according to claim 33, wherein the overpressure protection valve is adjustable.

36. The respiration apparatus according to claim 33, further comprising a valve housing, the non-return valve and the overpressure protection valve being disposed at the valve housing.

37. The respiration apparatus according to claim 36, wherein the valve housing is provided with one or more suction openings and wherein a part of a jacket surface of the valve housing is provided with one or more blow-off openings.

38. The respiration apparatus according to claim 36, wherein the valve housing comprises a clamp that secures the valve housing to the bellows.

39. The respiration apparatus of claim 6, wherein the valve housing comprises a means for connecting a bag so that the gas can pass from the bag to the bellows through the non-return valve.

40. The respiration apparatus of claim 36, wherein the valve housing comprises a means for connecting a bag so that the gas can pass from the bag to the bellows through the non-return valve.

41. The balloon unit of claim 13, wherein the overpressure protection valve is adjustable.

42. The balloon unit of claim 15, wherein the valve housing comprises a means for connecting a bag so that the gas can pass from the bag to the bellows through the non-return valve.

43. The balloon unit of claim 15, wherein the valve housing comprises a graduation identifying a relative angular position between an adjustable part of the valve housing and a stationary part of the valve housing, wherein the predetermined threshold value is a function of a relative position of the adjustable part with respect to the stationary part.

44. The respiration apparatus of claim 43, wherein there is a linear relationship between relative angular displacement between the adjustable and stationary parts and a change in the predetermined threshold value.
